(19) United States
(12) Patent Application Publication
(10) Pub. No.: US 2017/0083900 A1
(43) Pub. Date: Mar. 23, 2017

(54) METHOD FOR MOBILE PAYMENT

(71) Applicant: TELECOM ITALIA S.p.A., Milano (IT)

(72) Inventors: Felice Fulvio FARACI, Torino (IT); Fabio RICCIATO, Torino (IT); Nicolo VACCARO, Torino (IT)

(73) Assignee: TELECOM ITALIA S.p.A., Milano (IT)

(21) Appl. No.: 15/311,699

(22) PCT Filed: May 30, 2014
(86) PCT No.: PCT/EP2014/061241

§ 371 Date: Nov. 16, 2016

(51) Int. Cl. G06Q 20/32; G06K 19/06; G06Q 20/10

(52) U.S. Cl. CPC G06Q 20/3276; G06Q 20/102; G06K 19/06028; G06K 19/06037

(57) ABSTRACT

A method to perform a mobile payment by a mobile user device. The method includes, at the mobile user device: retrieving information indicative of a payment account of a recipient of the payment; acquiring an image of a displayed amount to pay and retrieving the amount to pay on the basis of the acquired image; and based on the retrieved information, performing the payment of the retrieved amount to pay to the recipient's payment account.

### TECHNICAL FIELD

The present invention relates to the field of mobile payment. In particular, the present invention relates to a method to perform a payment using a mobile user device such as a smartphone, a tablet, a PDA, or the like.

### BACKGROUND ART

Nowadays mobile payments are becoming increasingly common all around the world and typically they can be classified in two general categories, “proximity” and “online” payments.

Proximity payments (or contactless payments) are intended to be used in a physical store (also called “B&M—brick and mortar store”). They typically make use of near field communication (NFC) technology to perform communication between a mobile user device and a merchant point of sale (POS). The mobile user device may be a cellular phone, a smartphone, a tablet, a personal digital assistant (PDA), or the like, capable of sending and receiving data through a mobile network. Proximity payments make use of encrypted credit card information provisioned by a mobile network operator on a secure element (SE) of the mobile device. The secure element may be a subscriber identity module (SIM) of the mobile device. Example of systems currently implementing proximity payments making use of the NFC technology include MasterCard PayPass™ and Visa PayWave™.

Online payments are intended to be used remotely, for instance on a virtual store (e.g. a web/online store). As known, online payments can be performed using two different methods: a so-called “card present” transaction model and a so-called “remote” transaction model.

The first transaction model, namely the card present transaction model, may be implemented by using credit card information that are encrypted on the SE of the mobile device. The credit card information are transmitted from the mobile device to the remote server hosting the web store via a remote connection implemented through the mobile network. One example of card present transaction model is called “MasterPass™” and is implemented by MasterCard™.

The second transaction model, namely the remote transaction model, may be implemented by using the information visible on a plastic credit card (i.e. card number, expiration date and CVV2), which the user has previously stored on a secure web server. Online payments implementing a remote transaction model may be performed via the known PayPal™ system.

In general, proximity payments can be performed at B&M stores, while online payment can be performed both at B&M stores and online stores.

US 2012/0203693 A1 discloses a system for secure transactions according to which where a consumer shops at a brick and mortar store location, the consumer may checkout without swiping her credit or bank card, providing cash or writing a check, but being presented with a QR code by a client comprising a POS device located on the merchant's premises. The consumer may scan the QR code with a mobile device, by means of, e.g., a camera built into the mobile device. The mobile device may authenticate itself to a consumer's transaction account by way of a mobile gateway and payment processor authorization gateway, which pairs the mobile device with the consumer's transactions account. Using an address/pointer (e.g. a URL) encoded within the QR code and an internet connection, the mobile device may retrieve a consumer's shopping cart or purchase data from a merchant server or a merchant e-commerce website server. If the consumer wishes to complete the transaction, the mobile device may transmit an authorization request, via a cellular network or another wireless network, to the mobile gateway and the payment processor authorization gateway. The payment processor authorization gateway may transmit an authorization response to the merchant server and/or to the mobile device indicating approval or denial of the consumer's authorization request.

### SUMMARY OF THE INVENTION

The inventors noticed that it is still uncommon nowadays that B&M stores provide proximity or online payments. The inventors perceived that this is due to the high costs associated with such payment methods. Indeed, in order to provide proximity or online payments, the B&M store should be equipped with new cash registers or new POS devices implementing the NFC technology (the so-called NFC POS devices). Moreover, also the mobile user device (e.g. the smartphone) should be equipped with a dedicated NFC chip. Even if nowadays an increasing number of smartphones is equipped with a NFC chip, the number of B&M stores provided with a NFC POS device is still small due to the high costs associated with switching from traditional POS devices to NFC POS devices.

According to the method of US 2012/0203693 A1, the merchant should adapt its POS devices to generate QR codes. Hence, according to US 2012/0203693 A1, the merchant may provide the consumers with the possibility of proximity or online payments only by switching from traditional payment devices, namely traditional cash registers and traditional POS devices, to new payment devices capable of handling QR code generation. This is disadvantageously expensive.

In view of the above, the inventors have addressed the problem of providing a method for mobile payments which allows performing mobile payments in a cheap way for the merchant. In particular, the inventors have addressed the problem of providing a method for mobile payments which allows avoiding the costs associated with switching from traditional payment devices to new devices.

According to a first aspect, the present invention provides a method to perform a mobile payment by a mobile user device, the method comprising, at the mobile user device:

a) retrieving information indicative of a payment account of a recipient of the payment;
b) acquiring an image of a displayed amount to pay and retrieving the amount to pay on the basis of the acquired image; and
c) on the basis of the retrieved information, performing the payment of the retrieved amount to pay to the recipient's payment account.

Preferably, retrieving information indicative of a payment account comprises acquiring and decoding a code.

According to an embodiment of the present invention, the code is a 1D code. Preferably, the 1D code is a barcode.

According to other embodiments, the code is a 2D code. Preferably, the 2D code is one of: a quick response code, a model 1 QR code, a model 2 QR code, a micro QR code, an iQR code, a safety QR code, a LogoQ code, a ShotCode, a SPARQCode, a MaxiCode, a High Capacity Color Barcode, a Data Matrix, an Inverted QR Code.

According to alternative embodiments, retrieving information indicative of a payment account comprises pinpointing a position of the mobile user device through a localization service based on one or more of; a global positioning system, a mobile cellular system, an indoor positioning system.

According to further alternative embodiments, retrieving information indicative of a payment account comprises identifying an audio watermark.

Preferably, acquiring the code comprises acquiring an image of the code by a camera of the mobile user device.

According to embodiments of the present invention, the step of retrieving and the step of acquiring are performed substantially at the same time.

Preferably, in these cases, the method comprises acquiring an image comprising both the code and the displayed amount to pay by the camera of the mobile user device.

Preferably, retrieving the amount to pay comprises scanning the acquired image of a displayed amount to pay using a character text decoding technique.

Preferably, acquiring the image of a displayed amount to pay comprises a number of acquiring iterations and scanning the acquired image comprises:
at any iteration, processing the acquired image for improving a contrast thereof, and extracting a result by recognizing a text indicative of the amount to pay, recognizing being performed by using the character text decoding technique; and
skimming the results extracted at the iterations for selecting the most probable recognized text.

Preferably, the character text decoding technique is one of: an optical character recognition technique, an intelligent character recognition technique, an optical mark recognition technique.

According to a second aspect, the present invention provides a computer program product comprising computer-executable instructions for performing, when the program is run on a mobile user device, the steps of the method as set forth above.

According to a third aspect, the present invention provides a mobile user device configured to:
retrieve information indicative of a payment account of a recipient of a mobile payment;
acquire an image of a displayed amount to pay and retrieving the amount to pay on the basis of the acquired image; and
on the basis of the retrieved information, performing the payment of the retrieved amount to pay to the recipient's payment account.

### BRIEF DESCRIPTION OF THE DRAWINGS

The present invention will become clearer from the following detailed description, given by way of example and not of limitation, to be read with reference to the accompanying drawings, wherein:

FIG. 1 is a flow chart representing the steps of the method according to the present invention;

FIG. 2 is a flow chart illustrating in more detail the step of acquiring and scanning an image indicative of an amount to pay according to embodiments of the present invention;

FIG. 3 is a use case diagram illustrating the interaction between a consumer and a merchant, via a payment service, according to an embodiment of the present invention;

FIG. 4 schematically shows a display of an exemplary cash register in the use case embodiment of FIG. 3; and

FIG. 5 schematically shows a mobile user device suitable for performing the method of the present invention according to the use case embodiment of the present invention.

### DETAILED DESCRIPTION OF PREFERRED EMBODIMENTS OF THE INVENTION

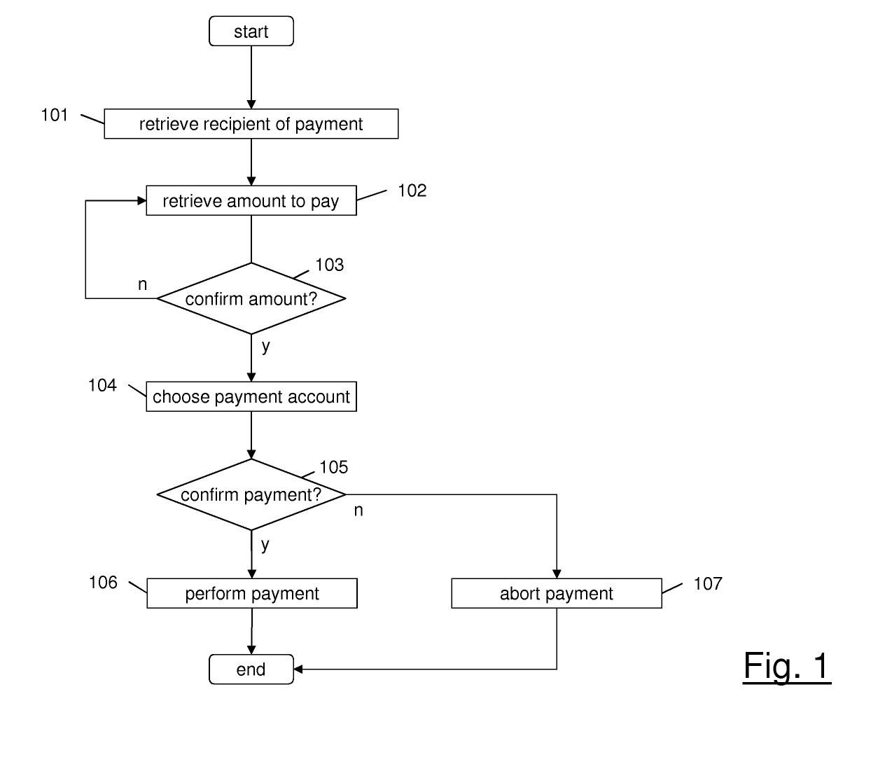

FIG. 1 is a flow chart of the steps of the method according to embodiments of the present invention. The method is performed by a consumer wishing to perform a mobile payment at a store (either a B&M store or an online store) of a merchant through a mobile user device. The term “merchant” will indicate a supplier or seller of goods and/or services, including any operator working at/for the store (e.g. a cashier). Accordingly, the merchant's store may be any kind of store selling goods and/or services. Goods may comprise clothes, food, electronic appliances, newspapers, books, tickets, etc. Services may comprise travels, subscriptions, etc.

The mobile user device is preferably capable of sending and receiving data through a mobile or cellular network. Moreover, the mobile user device is preferably configured to acquire images, in particular take pictures or photographs or the like. Preferably, the mobile user device comprises a camera. The mobile user device may comprise a cellular phone, a smartphone, a PDA, a tablet or the like.

Preferably, the consumer holds one or more payment accounts for performing payments, such as for instance a credit based transaction account (for instance, a Mastercard™ or Visa™ account), a bank account, an e-wallet account (for instance, Google™ wallet), and the like.

According to embodiments of the present invention, the consumer registers to a payment service allowing her/him to perform mobile payments, as described above. Examples of such payment services are the already cited Masterpass™ and PayPal™.

Preferably, upon registration, information identifying the payment account(s) of the consumer is stored on a payment server of the payment service. Alternatively or concurrently, the consumer account information may be stored on a secure element, such as a subscriber identity module (SIM), of the mobile user device. In this case, preferably, the consumer account information are encrypted. The information identifying the payment account(s) comprise data necessary per performing payments. The information identifying the payment account(s) may comprise a card number, an expiration date and a card security code (e.g. a card verification value 2, or CVV2) of a consumer's credit card. The information identifying the payment account(s) may comprise an international bank account number (IBAN) of a consumer's bank account. Furthermore, when the consumer registers to the payment service, she/he may also provide contact information, such as a phone number and/or an e-mail.

According to embodiments of the present invention, information identifying payment's recipients for a number of merchants are stored in a recipient server. In particular, the recipient server preferably stores information identifying a number of merchants and, for each of them, corresponding information identifying the recipient account for receiving payments. The former information may comprise a contact information of the merchant, for instance a phone number and/or an e-mail address. The latter information may include information identifying a bank account of the payment's recipient (e.g. an IBAN). Each recipient account may be associated with at least one respective merchant. The information identifying a merchant will be indicated in the following as merchant identifier, while the information identifying a recipient account will be indicated as recipient account identifier.

According to the method of the present invention, when a consumer whishes to purchase a good or service at a merchant's store (either a B&M store or an online store), at step 101, she/he preferably operates her/his mobile user device to automatically and unidirectionally retrieve a merchant identifier and/or a corresponding recipient account identifier. In the present description, the expression “automatically and unidirectionally retrieve a merchant identifier and/or a corresponding recipient account identifier” indicates that the related operation is performed without establishing any type of bidirectional communication with a merchant's payment device, such as a cash register or a POS device. This means that according to the method of the present invention, the payment device(s) of the merchant are not required to be configured to provide any other functionality than the “traditional” ones.

In particular, retrieval of the merchant identifier and/or the recipient account identifier may be performed by acquiring and decoding a code, for instance a 1D code or a 2D code.

The 1D code may be a barcode. The 2D code may be any one of: a quick response (QR) code, a model 1 QR code, a model 2 QR code, a micro QR code, an iQR code, a safety QR code (SQRC), a LogoQ code, a ShotCode, a SPARQCode, a MaxiCode, a High Capacity Color Barcode, a Data Matrix, an Inverted QR Code, or the like.

The 1D or 2D code preferably encodes the merchant identifier and/or the recipient account identifier. In case the 1D or 2D code encodes only the merchant identifier, the recipient account identifier may be recovered by the mobile user device by interrogating the recipient server on the basis of the merchant identifier.

In case consumer's shopping is made at a B&M store, the 1D or 2D code may be exposed directly in the B&M store. Preferably, the 1D or 2D code is exposed in the proximity of a display of the device used for presenting the amount to pay to consumers, for instance a cash register or a POS device. In this case, the consumer may acquire the code by acquiring an image of it with the camera of the mobile user device. This preferably comprises framing the code with the camera of the mobile user device.

In case consumer's shopping is made at an online store, the 1D or 2D code may be comprised in a web page of the online store and displayed on a monitor of a device through which the consumer is interfacing with the online store (e.g. a personal computer or a tablet). Also, in this case, the consumer may acquire the code by acquiring an image of it with the camera of the mobile user device. This preferably comprises framing the display of the monitor (or a portion thereof) showing the web page comprising the code with the camera of the mobile user device.

According to embodiments of the present invention, the consumer may then manually take a picture of the code with the camera of the mobile user device or the image may be automatically acquired by the camera of the mobile user device while the consumer is framing the code.

The operation of decoding 1D or 2D codes as those mentioned above is known in the art and will not be described herein after.

According to another embodiment of the present invention, retrieval of the merchant identifier and/or the recipient account identifier may be performed by the mobile user device by pinpointing its position in the B&M store through a localization service of any type (e.g. Google Maps™). This service could be based on different positioning systems, for instance on a global positioning system, typically satellite based (such as GPS, Glonass or Galileo), a mobile cellular system, and/or an indoor positioning system based on a wireless technology or a low-power wireless technology, such as, for instance, the Bluetooth™ technology, the Bluetooth™ Low Energy (BLE) technology, the Wi-Fi technology or the Wi-Fi Direct technology, or a combination of the above. An example of an indoor positioning system is iBeacon™ by Apple Inc. After retrieval of the position of the mobile user device, the method provides for recovering the merchant identifier on the basis of such position information using the same localization service and/or indoor positioning system. Then, the method provides for recovering the recipient account identifier by interrogating the recipient server on the basis of the merchant identifier.

According to a further embodiment of the present invention, retrieval of the merchant identifier may be performed by the mobile user device by identifying an audio watermark or the like indicative of the merchant identity. The audio watermark is a digital identifier embedded in an audio signal, audible or non audible. In case shopping is made at a B&M store, the audio signal may be broadcast inside the store by a device belonging to the merchant (e.g. a loudspeaker). In case shopping is made at an online store, the audio signal may be output by a loudspeaker of the device through which the consumer is interfacing with the online store. According to this embodiment, the user preferably receives the audio signal via a microphone of her/his mobile user device. A dedicated software application installed on the mobile user device may then process the audio watermark embedded in the audio signal and retrieve the merchant identifier. After retrieval of the merchant identifier, the recipient account identifier may be recovered by interrogating the recipient server on the basis of the merchant identifier.

Alternatively, the merchant identifier and/or the recipient account identifier may be stored in a NFC tag which may be exposed within the B&M store. The consumer may retrieve such information by tapping the NFC tag. In this case, the mobile user device is preferably configured to implement the NFC technology.

Then, at step 102, the consumer preferably operates its mobile user device to automatically and unidirectionally retrieve an amount to pay. Similarly to the operation performed at step 101, the expression “automatically and unidirectionally retrieve an amount to pay” indicates that also the operation at step 102 is performed without establishing any type of bidirectional communication (such, as, for instance, a near field communication) with the merchant's payment device. Preferably, retrieval of the amount to pay is performed by acquiring at least one image indicative of the amount to pay. The operation of “acquiring at least one image indicative of the amount to pay” preferably comprises the consumer's operation of framing the amount to pay with the camera of the mobile user device.

In case the consumer's shopping is made at a B&M store, the image of the amount to pay may be acquired by framing the display (or a portion thereof) of the cash register indicating the amount to pay at checkout or, alternatively, by framing a paper receipt at checkout indicating the amount to pay.

In case the consumer's shopping is made at an online store, the image of the amount to pay may be acquired by framing the display (or a portion thereof) of a monitor of the device used by the consumer for interfacing with the online store, the monitor showing a web page indicating the amount to pay.

Moreover, according to an embodiment of the present invention, the operation of framing the amount to pay is associated with taking a picture of the amount to pay with the camera by manually operating it.

Alternatively, according to other embodiments of the present invention, the operation of framing the amount to pay is associated with acquiring multiple consecutive images in an automatic manner by the mobile user device, as it will be described in greater detail herein after.

Accordingly, the “acquired image” mentioned herein after may be the picture taken manually by the user, or any image within the set of images that are automatically taken by the camera of the mobile user device when the consumer is framing the amount to pay.

Then, the acquired image is preferably scanned by the mobile user device using a character text decoding technique in order to recognize the amount to pay. The character text decoding technique may be one of the following known techniques: the optical character recognition (OCR) technique, the intelligent character recognition (ICR) technique, the optical mark recognition (OMR) technique.

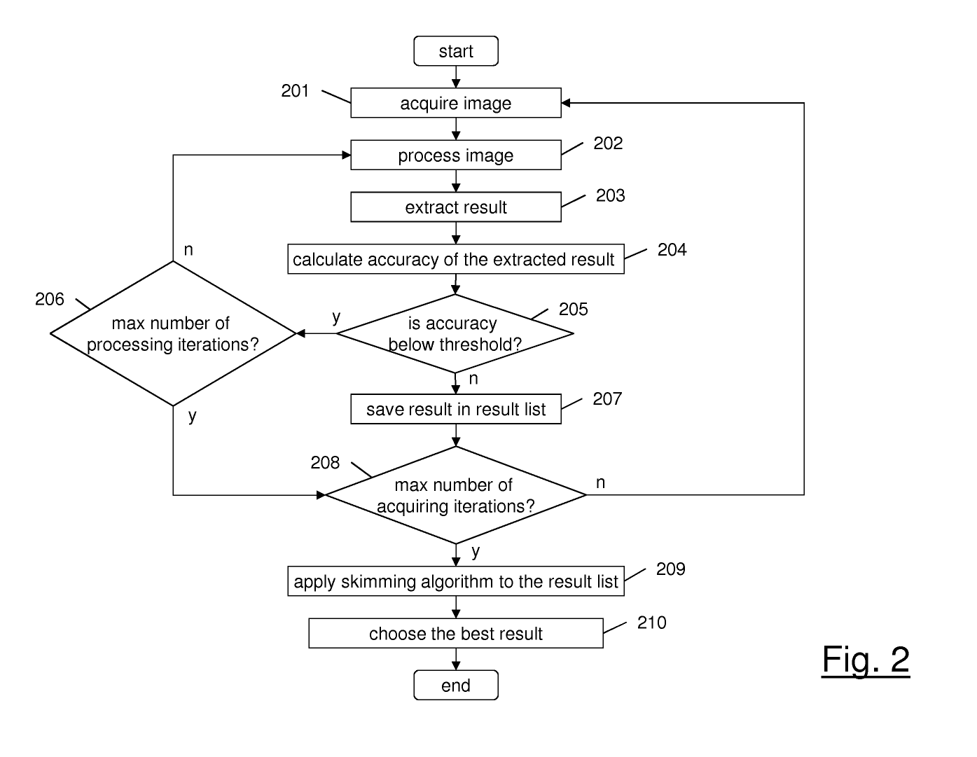

The operation of acquiring and scanning the image indicative of the amount to pay at step 102 will be described in greater detail herein after with reference to the flowchart of FIG. 2.

At step 201, an image indicative of the amount to pay is acquired by the mobile user device. As mentioned above, this image may be a picture taken manually by the user operating a camera of her/his mobile user device. Alternatively, it may be one image of a sequence of images taken automatically by the camera when the consumer is framing the amount to pay.

In the latter case, a maximum number of acquiring iterations is pre-determined and set in the mobile user device, and the camera of the mobile user device is operated to take a number of consecutive images equal to the maximum number of acquiring iterations when the user frames the amount to pay. In the meanwhile, steps 202-208 are performed for each acquired image.

At step 202, the image is processed in order to facilitate the subsequent character text recognition. In particular, image processing may comprise improving a contrast of the image by, for instance, converting an RGB image into a binary (black & white) image. At step 203, the method provides for extracting a result by recognizing the text indicative of the amount to pay from the processed image. This is performed by implementing a selected character text decoding technique among those mentioned above. At step 204, an accuracy of the extracted result is preferably computed, on the basis of one or more properties of the result, such as for instance a meaning confidence of the result (i.e. a confidence information for the correctness of the recognized text). At step 205, the computed accuracy of the extracted result is compared to an accuracy threshold. In case the accuracy of the extracted result is lower than the threshold, the method provides for, at step 206, checking whether a maximum number of processing iterations is reached; in the negative, the acquired image is processed again, i.e. steps 202-205 are repeated. Steps 202-205 are iterated until the accuracy of the extracted result reaches the accuracy threshold, or a maximum number of processing iterations is reached at step 206. When the accuracy of the currently extracted result reaches the accuracy threshold, the currently extracted result is preferably saved in a result list (step 207).

Preferably, if, at step 206, it is checked that the maximum number of processing iterations is reached and the accuracy of the extracted result still does not reach the threshold, the extracted result is not saved in the result list.

At step 208, it is checked whether the maximum number of acquiring iterations is reached. In case the maximum number of acquiring iterations is not reached, steps 201-207 are preferably repeated, i.e. another image acquisition is taken and the acquired image is processed again as described above, until the extracted result (if sufficiently accurate) is saved in the result list or the maximum number of processing iterations is reached.

The result list preferably comprises the results extracted from the successively acquired images, such results having an accuracy equal to or higher than the accuracy threshold.

When the maximum number of acquiring iterations is reached, a skimming algorithm is preferably applied to the extracted results comprised within the result list (step 209). The skimming algorithm may be based on the meaning confidence or the other properties of the results, as computed at step 204. Skimming the results of the character text decoding applied to the acquired images leads to, at step 210, selecting of a “best” result among the extracted results. For instance, the method may end at step 210 with selection of the most probable recognized text from the result list.

It is to be noticed that, for the embodiment according to which a picture of the amount to pay is manually taken, only steps 201-206 are preferably performed and steps 202-206 may be iterated until the accuracy of the result extracted from the picture reaches the accuracy threshold.

With reference again to FIG. 1, it is to be noticed that even if, in the foregoing description, steps 101 and 102 have been described as subsequent steps, this is not limiting as these steps may have also the opposite order. Moreover, according to further embodiments of the present inventions the operations of retrieving the merchant identifier and/or the corresponding recipient account identifier and retrieving the amount to pay are performed substantially at the same time. According to these further embodiments, the consumer may operate the mobile user device to acquire at least one image comprising both the code, for instance a QR code, encoding the merchant identifier and/or the corresponding recipient account identifier and the amount to pay (e.g. on a display of a cash register or a POS device). In the light of the above, acquiring at least one image comprising both the code and the amount to pay is preferably performed by framing simultaneously the code and the amount to pay with the camera of the mobile user device. Then, a single picture may be manually taken by the user or the mobile user device may acquire multiple consecutive images while framing is performed. In any case, the code is decoded as described above for retrieving the payment's recipient while the steps of the flowchart of FIG. 2 are preferably performed for retrieving the amount to pay.

Optionally, once an amount to pay has been retrieved, at step 103, the method of the present invention provides for obtaining from the consumer a confirmation about the amount to pay. Indeed, the retrieved amount may not be correct (because for instance, the character text decoding has failed and retrieved a wrong amount to pay), or the consumer may wish to modify it for adding, e.g., a tip. Step 103 is preferably performed at the mobile user device by asking the consumer to confirm the retrieved amount.

Once the amount to pay has been retrieved (and, optionally, it is confirmed at step 103), the consumer preferably operates the mobile user device to retrieve information identifying the consumer's payment account(s), namely the consumer's payment account(s) that she/he has stored on the payment server (and/or on the SIM). In order to do that, the mobile user device preferably connects to the payments server, retrieves the information identifying the consumer's payment account(s) and provides the consumer with a list of the related one or more payment accounts. Alternatively, the mobile user device may retrieve such information from the SIM. Then, the mobile user device is preferably operated to ask the consumer to choose one of her/his payments accounts in order to perform the payment. At this point, the consumer preferably operates the mobile user device to select the payment account she/he has chosen to perform the payment (step 104)

If, at optional step 103, the consumer does not confirm the retrieved amount, the method of the present invention preferably provides for asking the consumer whether she/he wishes to repeat retrieving the amount to pay or to directly provide the amount to pay to the mobile user device. If the consumer whishes to repeat retrieving the amount to pay, the method of the present invention provides for repeating all or part of the operations of step 102. In particular, the consumer may operate the mobile user device to repeat steps 201-210 of the flowchart of FIG. 2 in order to retrieve the amount to pay.

If, otherwise, the consumer wishes to directly provide the amount to pay to the mobile user device, the consumer may manually enter the amount, for instance by using a keyboard of the mobile user device or using a voice input.

Optionally, at step 105, the method of the present invention provides for checking whether the consumer whishes to confirm the payment. Checking preferably comprises, at the mobile user device, presenting to the consumer resumptive information comprising one or more of: the merchant identifier, the information indicative of the recipient account, the amount to pay and the chosen payment account. Then, checking preferably comprises asking the consumer to confirm the payment on the basis of the presented resumptive information.

If the consumer confirms the payment, she/he preferably operates the mobile user device for interacting with the payment service (e.g. MasterPass™, PayPal™) to which the consumer has registered to perform the payment (step 106). In particular, with the expression “perform the payment” it is intended that the mobile user device preferably connects to a payment processor of the payment service through the mobile network and sends to the payment processor a request comprising the recipient account information, the information indicating the amount to pay and the information indicating the selected payment account. Further, the request may comprise the merchant identifier, and in particular a merchant contact information such as an e-mail address and/or a phone number. The payment processor preferably processes the request and authorizes or denies it, in accordance with procedures that are known in the art and that hence will not be further described herein after.

According to embodiments of the method of the present invention, after processing the request, the payment processor provides a response to both the merchant and the consumer indicating whether the payment is authorized or denied. The response is sent to a consumer's device (for instance, the mobile user device cited above) and it may be in the form of an e-mail, a short message service (SMS), a push message on a payment service software application installed on the device, or the like. The contact information associated with the consumer's device to which the response is sent (e-mail address, phone number, etc.) is preferably maintained by the payment server (e.g. the consumer may have provided them to the payment server at the moment of registration). Analogously, a response is sent to a merchant's device (e.g. a personal computer) and it may be in the form of an e-mail, a short message service (SMS), a push message on a payment service software application installed on the device, or the like. The contact information associated with the merchant's device to which the response is sent may be retrieved by the payment processor from the data comprised in the request received from the mobile user device.

If the consumer does not confirm the payment, payment is aborted (step 107).

Optionally, if the consumer does not confirm the payment, the method of the present invention may provide for asking the consumer whether she/he wishes to modify the information indicative of recipient account and/or the amount to pay and/or the payment account. Advantageously, this allows correcting wrongly retrieved information or changing the method of payment. In the affirmative, the consumer may operate the mobile user device to modify one or more of the information above as follows: by repeating step 101 of the flowchart of FIG. 1 for modifying the recipient account identifier and/or by repeating step 102 for modifying the amount to pay and/or by repeating step 104 for choosing another payment account. Alternatively, the consumer may directly provide the modified information to the mobile user device by, e.g., using a keyboard of the mobile user device or via a voice input.

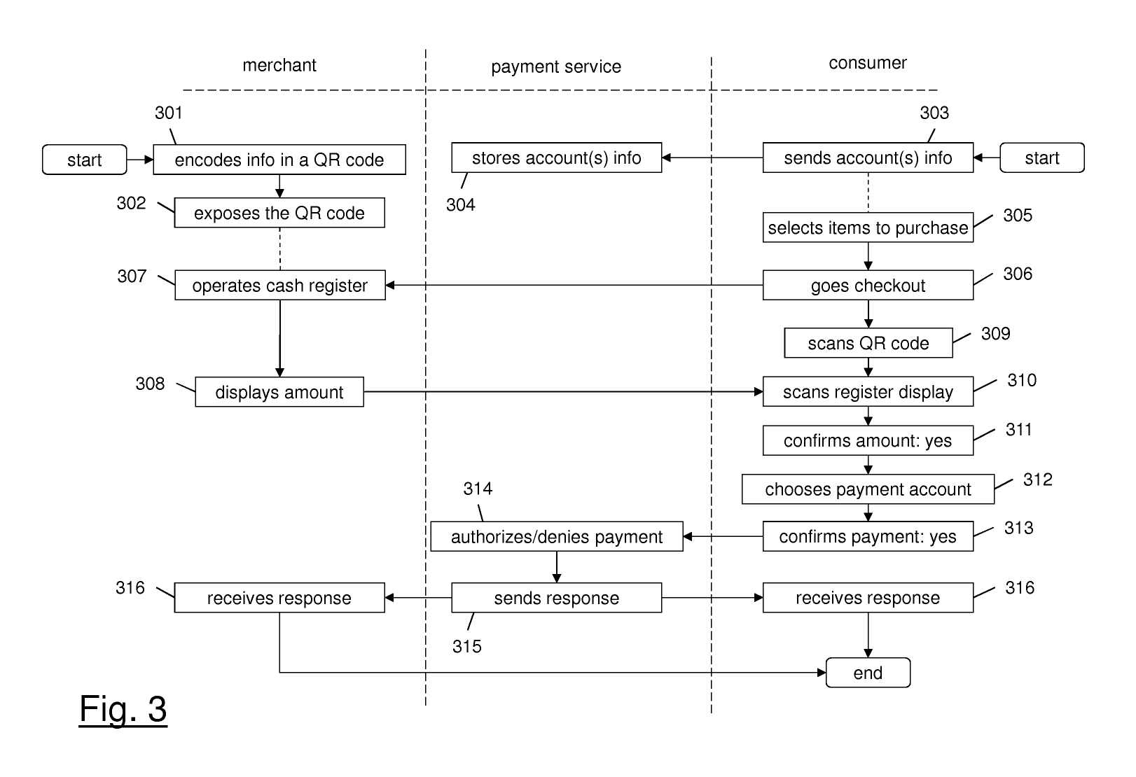

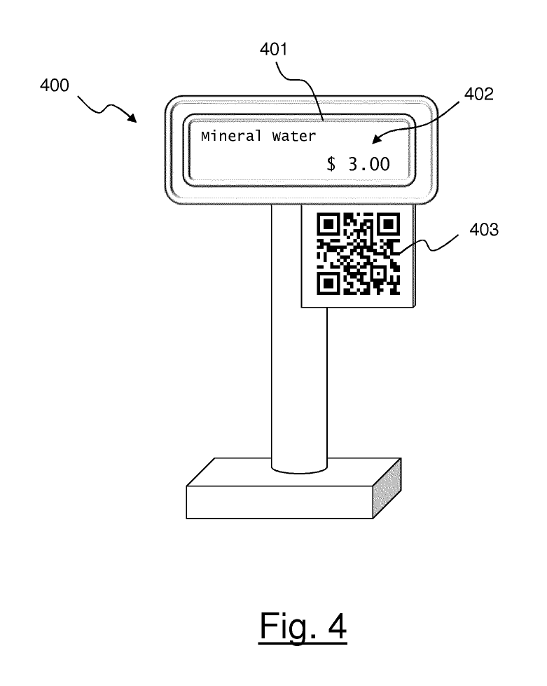

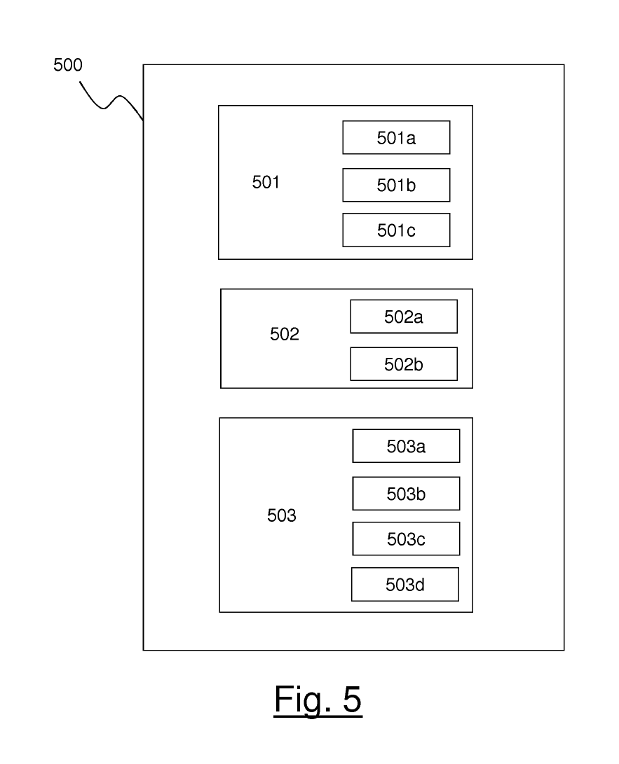

FIG. 3 is a flow chart illustrating a use case of the method of the present invention, according to a specific embodiment. FIG. 4 shows a display of an exemplary cash register for the use case. FIG. 5 schematically shows a mobile user device configured to perform the method according to this specific embodiment.

FIG. 3 shows some operations performed by the merchant and the consumer when the method of the present invention is implemented at a merchant's store, in particular a B&M store, together with some steps in charge of the payment service to which the consumer registers, as described above. It is to be noticed that the steps in charge of the consumer are performed via the mobile user device of the consumer through interaction with the consumer her/himself. Moreover, it is to be noticed that steps 309-313 in charge of the consumer correspond to those described above with reference to the flowchart of FIG. 1, but the language used for describing them may not be exactly the same as above since now it reflects the exemplary use case.

At step 301, the merchant preferably encodes a merchant identifier and/or a recipient account identifier for payments of goods or services on sale at the merchant's store in a QR code. According to this use case, the store is a B&M store provided with a device suitable for displaying an amount to pay, for instance a cash register and/or a POS device. At step 302, the merchant preferably exposes the QR code in the proximity of the display of the cash resister or the display of the POS device, as represented in FIG. 4.

FIG. 4 shows a portion of a cash register 400 comprising a display 401. On a portion 402 of the display 401, an amount to pay is shown. In this exemplary situation, a QR code is positioned below the display 401 of the cash register 400, preferably in the proximity of the portion 402 showing the amount to pay.

At step 303, the consumer preferably registers at a payment service by sending information indicative of her/his payments account(s) to a payment server. Further, the consumer sends to the payment server contact information such as an e-mail address and/or a phone number. The information sent by the consumer is preferably stored at a payment server of the payment service (step 304).

Moreover, the consumer is provided with a mobile user device. FIG. 5 shows a mobile user device 500 according to this embodiment of the present invention. The mobile user device 500 may be a cellular phone, smartphone, a tablet, a PDA or the like, capable of sending/receiving data through the mobile network. The mobile user device 500 preferably comprises a camera, not shown in FIG. 5. Further, the mobile user device 500 preferably comprises a camera manager 501, a QR code scanner 502 and an OCR scanner 503.

The camera manager 501 preferably comprises a previewing module 501a, a light managing module 501b and a focus managing module 501c. The previewing module 501a is preferably configured to generate a preview of an image, picture, photograph or the like captured by the camera. The light managing module 501 b is preferably configured to manage the light of a captured image and the focus managing module 501c is preferably configured to manage the focus of a captured image.

The operations performed by these modules are well known in the art and hence will not be further described herein after. The QR code scanner 502 preferably comprises a user interface 502a with a viewfinder, cooperating with the camera and the previewing module 501 a of the camera manager 501, through which the consumer may frame a QR code. The QR code scanner 502 preferably further comprises a decoding module 502b which is configured to decode the QR code and extract the information encoded therein. Also the operation of decoding a QR code is well known in the art and hence will not be further described herein after.

The OCR scanner 503 preferably comprises a user interface 503a with a viewfinder, cooperating with the camera and the previewing module 501 a of the camera manager 501, through which the consumer may frame an amount to pay on the portion 402 of the display 401 of the cash register display 400. The OCR scanner is preferably configured to perform steps 202-210 described above with reference to the flowchart of FIG. 2. In particular, the OCR scanner 503 preferably comprises an image processing module 503b which is configured to process the captured image in order to improve its accuracy and facilitate the character text recognition, as described above with reference to step 202 of the flowchart of FIG. 2. As already described above, image processing may comprise improving a contrast of the image by, for instance, converting an RGB image into a binary (black & white) image. Then, the OCR scanner 503 preferably comprises a decoding module 503c, cooperating with the image processing module 503b and with the camera, which is configured to perform steps 203-207 described above, in particular to recognize the text from the processed image by implementing OCR decoding. The OCR decoding is well known in the art and hence will not be described herein after. The OCR scanner 503 preferably comprises a skimming result module 503d which is preferably configured to perform steps 209 and 210 described above, in particular to skim the results of the OCR decoding so as to get the most probable recognized text from a set of possible results.

The modules above may be implemented either as hardware modules, software modules or hardware modules capable of executing a dedicated software.

The description above related to the mobile user device is not intended to be limited to the use case embodiment. More generally, the mobile user device, according to the present invention, comprises hardware and/or software modules configured to perform the steps of the method of the present invention according to one or more of the embodiments described above. For instance, for decoding barcodes instead of (or in addition to) QR codes, the mobile user device may be equipped with a barcode scanner module substituting or integrating the QR code scanner module described above. Further, for retrieving the merchant's identity by pinpointing the position of the mobile user device instead of (or in addition of) decoding a 1D and/or a 2D code, the mobile user device may be equipped with a module configured to connect to a global positioning system and/or an indoor positioning system, as described above, possibly in addition to the barcode/QR code scanner modules described above. Moreover, the OCR scanner module may be substituted or integrated with other modules configured to decode and process the captured images of the amount to pay according to another character text deciding technique such as ICR (intelligent character recognition) and OMR (optical mark recognition).

Moreover, according to the present invention, the mobile user device preferably comprises a graphical user interface (GUI) suitable for allowing the consumer to interact with the mobile user device in order to perform the method of the present invention. In particular, the dedicated GUI preferably comprises a main panel, through which the consumer may operate the mobile user device to start executing the method of the present invention (according to the description above, this is preferably performed before the mobile user device is operated to retrieve the merchant identifier and/or the recipient account identifier as provided at step 101 of FIG. 1) and a number of windows through which the consumer may interact with the mobile user device for those steps requiring the consumer's intervention, as described above. These steps are, for instance, confirming the amount to pay (step 103), confirming the payment (step 105), etc. as described above.

According to the considered use case, when the consumer goes shopping at the B&M store of the merchant, she/he preferably selects one or more items to purchase (step 305). As represented in FIG. 4, the consumer may decide to purchase a bottle of mineral water. When the consumer intends to checkout (step 306) approaching the cash register, the cashier preferably operates the cash register (step 307) which displays the amount to pay (step 308). In the meanwhile, the consumer preferably operates her/his mobile user device 500 to start executing the method of the present invention. This may be done by accessing the main panel of the dedicated GUI by acting on a corresponding virtual button displayed on the display of the mobile user device. Then, the consumer preferably operates the camera, the previewing module 501a of the camera manager 501 and the user interface 502a of the QR scanner 502, so that the mobile user device 500 frames the QR code. Then, the mobile user device 500, in particular the decoding module 502b, preferably decodes the QR code within the captured image to retrieve the merchant identifier and/or the recipient account identifier. All these operations are indicated as “scans QR code” at step 309. It will be appreciated that step 309 of the use case corresponds to step 101 of the flowchart of FIG. 1.

If only the merchant identifier is retrieved at this step, the mobile user device 500 preferably uses the merchant identifier for retrieving the recipient account identifier from the recipient server, as already described above.

Once the cashier operated the cash register to show the amount to pay on display 401, the consumer preferably operates her/his mobile user device 500, in particular the camera, the previewing module 501a of the camera manager 501 and the user interface 503a of the OCR scanner 503, so that the mobile user device 500 frames the cash register display 401 or the portion thereof 402 showing the amount to pay. Then, the mobile user device 500, in particular the image processing module 503b, preferably processes the captured image, as described above. Finally, the mobile user device 500, in particular the decoding module 503c and the skimming result module 503d, preferably recognizes the text comprised in the captured image, namely the amount to pay, by means of OCR decoding. All these operations are indicated as “scans register display” at step 310. It will be appreciated that step 310 of the use case corresponds to step 102 of the flowchart of FIG. 1 and hence comprises the steps of the flowchart of FIG. 2.

It is to be noticed that the consumer, through the camera of the mobile user device 500, may frame simultaneously both the QR code and the portion of the cash register display showing the amount to pay. The QR code scanner 502 and the OCR scanner 503 of the mobile user device 500 then preferably both handle the image as described above for retrieving, respectively, the information about the merchant identifier and/or the recipient account identifier and the amount to pay.

According to this use case, at step 311, the consumer is asked to confirm the amount to pay. This step corresponds to step 103 of the flowchart of FIG. 1. This may be done at the mobile user device by presenting to the consumer the retrieved amount to pay on the display of the mobile user device together with a request to confirm this amount. It is assumed here for sake of example that the retrieved amount to pay is correct and that the consumer confirms it. Then, at step 312, the consumer preferably chooses a payment account for performing the payment. This step corresponds to step 104 of the flowchart of FIG. 1. This may be done at the mobile user device by presenting to the consumer a list of the payment accounts of the consumer, as already described above. Once the consumer has chosen a payment account, she/he is asked to confirm the payment (step 313). Step 313 corresponds to step 105 of the flowchart of FIG. 1. This may be done at the mobile user device by presenting to the consumer the resumptive information about her/his purchase as described above together with a request to confirm the payment. It is assumed here for sake of example that the consumer confirms the payment. This way she/he expresses her/his willing to complete the transaction after reviewing the information about, for instance, the recipient of the payment, the amount to pay and the chosen payment account.

Upon confirmation of the payment by the consumer, the mobile user device connects to the payment processor which authorizes or denies the payment (step 314). In any case, the payment processor sends a response to the mobile user device and to a merchant's device (steps 315), such response indicating the outcome of the payment procedure. At step 316, the merchant and the consumer receive the response indicating the outcome of the payment transaction. These steps related to performing the payment correspond to step 106 of the flowchart of FIG. 1.

Advantageously, the method of the present invention allows performing mobile payments in a simple and cheap manner. Indeed, on the one hand, a consumer may, in any situation (either in a B&M store or an online store), perform a payment using only her/his mobile user device by performing very simple actions, i.e. using the camera and interacting with the mobile user device for confirming operations. The consumer does not need to memorize any payment information nor she/he has to physically hold any payment card. On the other hand, the merchant has the possibility to offer a mobile payment solution at a B&M store without having to switch from traditional payment devices (cash register and/or POS device) to new ones. Indeed, the payment procedure is performed entirely by the mobile user device interacting with the payment service through the mobile network, and the cash register or the POS device are used only for displaying the amount to pay. As apparent, this may be done with any traditional device. This results in a great reduction of costs with respect, for instance, to providing proximity payments at a B&M store based on the NFC technology.

1-15. (canceled)

16. A method to perform a mobile payment by a mobile user device, the method comprising, at the mobile user device:
retrieving information indicative of a payment account of a recipient of the payment;
acquiring an image of a displayed amount to pay and retrieving the amount to pay based on the acquired image; and
based on the retrieved information, performing the payment of the retrieved amount to pay to the recipient's payment account.

17. The method according to claim 16, wherein the retrieving information indicative of a payment account comprises acquiring and decoding a code.

18. The method according to claim 17, wherein the code is a 1D code or a 2D code.

19. The method according to claim 18, wherein the 1D code is a barcode.

20. The method according to claim 18, wherein the 2D code is one of: a quick response code, a model 1 QR code, a model 2 QR code, a micro QR code, an iQR code, a safety QR code, a LogoQ code, a ShotCode, a SPARQCode, a MaxiCode, a High Capacity Color Barcode, a Data Matrix, an Inverted QR Code.

21. The method according to claim 16, wherein the retrieving information indicative of a payment account comprises pinpointing a position of the mobile user device through a localization service based on one or more of: a global positioning system, a mobile cellular system, an indoor positioning system.

22. The method according to claim 16, wherein the retrieving information indicative of a payment account comprises identifying an audio watermark.

23. The method according to claim 17, wherein the acquiring the code comprises acquiring an image of the code by a camera of the mobile user device.

24. The method according to claim 16, wherein the retrieving and the acquiring are performed substantially at a same time.

25. The method according to claim 23, further comprising acquiring an image comprising both the code and the displayed amount to pay by the camera of the mobile user device.

26. The method according to claim 16, wherein the retrieving the amount to pay comprises scanning the acquired image of a displayed amount to pay using a character text decoding technique.

27. The method according to claim 26, wherein the acquiring the image of a displayed amount to pay comprises a plurality of acquiring iterations, and scanning the acquired image comprises:
at any iteration, processing the acquired image for improving a contrast thereof, and extracting a result by recognizing a text indicative of the amount to pay, the recognizing being performed by using the character text decoding technique; and
skimming results extracted at the iterations for selecting a most probable recognized text.

28. The method according to claim 26, wherein the character text decoding technique is one of: an optical character recognition technique, an intelligent character recognition technique, an optical mark recognition technique.

29. A non-transitory computer readable medium comprising computer program product comprising computer-executable instructions for performing, when the program is run on a mobile user device, the method according to claim 16.

30. A mobile user device configured to:
retrieve information indicative of a payment account of a recipient of a mobile payment;
acquire an image of a displayed amount to pay and retrieve the amount to pay based on the acquired image; and
based on the retrieved information, perform the payment of the retrieved amount to pay to the recipient's payment account.
